(19) United States
(12) Patent Application Publication
(10) Pub. No.: US 2026/0265083 A1
(43) Pub. Date: Sep. 10, 2026

(54) METHOD FOR PREDICTING WASTEWATER TREATMENT PERFORMANCE

(71) Applicant: SAMSUNG ELECTRONICS CO., LTD., Suwon-si (KR)

(72) Inventors: Daeseon PARK, Suwon-si (KR); Seoktae Kang, Daejeon (KR); Inhyeok Kim, Suwon-si (KR); Dongseoung Shin, Suwon-si (KR); Inseo Yoon, Suwon-si (KR); Hansol Jang, Suwon-si (KR); Junho Kim, Daejeon (KR); Thi Nhung Tran, Daejeon (KR); Junha Hwang, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/290,966

(22) Filed: Aug. 5, 2025

(30) Foreign Application Priority Data
Mar. 4, 2025 (KR) 10-2025-0027414

(51) Int. Cl. C02F 1/00; C02F 1/20; C02F 1/44; C02F 101/16

(52) U.S. Cl. CPC C02F 1/008; C02F 1/20; C02F 1/448; C02F 2101/16; C02F 2209/02; C02F 2209/06; C02F 2209/14; C02F 2209/40

(57) ABSTRACT

An embodiment of the present disclosure provides a method for predicting a membrane contact process performance of a membrane contact device that removes ammonia contained in wastewater, the method including: inputting the wastewater conditions; inputting membrane contact process conditions of the membrane contact device; and predicting the removal rate of ammonia removed from the wastewater using a prediction model that calculates the removal rate of ammonia, the prediction model including equations using the wastewater conditions and the membrane contact process conditions.

### CROSS-REFERENCE TO RELATED APPLICATION

This application claims priority to and the benefit of Korean Patent Application No. 10-2025-0027414 filed with the Korean Intellectual Property Office on Mar. 4, 2025, the entire contents of which are incorporated herein by reference.

### BACKGROUND

### 1. Field

The present disclosure relates to a method for predicting wastewater treatment performance, and to a method for predicting wastewater treatment performance in the treatment of wastewater containing high concentration ammonia using a membrane contact process.

### 2. Description of Related Art

Conventionally used low-concentration ammonia removal technologies include the breakthrough chlorine injection method and the electrochemical oxidation method. However, in the case of wastewater containing high concentrations of ammonia, there is a disadvantage of incurring excessive costs.

For wastewater containing high concentrations of ammonia, absorption methods using scrubbers are currently mainly used. However, these methods have the disadvantage of consuming excessive energy to create small droplets and requiring a large space to ensure contact time between the droplets and ammonia gas.

Transmembrane chemisorption (TMCS), a recently used technology for removing ammonia, is a technology that removes ammonia from a gas or aqueous solution containing ammonia through an absorbent. This method uses a porous hydrophobic membrane to flow wastewater containing ammonia and an absorbent liquid into and out of the porous hydrophobic membrane, respectively, and utilizes the principle that vaporized pollutants such as ammonia move toward the absorbent liquid through the pores of the membrane due to the concentration difference.

The membrane contact process has an effective contact area 30 times greater than that of a general absorption process in the same volume, so the process area is small compared to the treatment efficiency, and it is highly efficient in removing ammonia from high-concentration ammonia wastewater.

### SUMMARY

The embodiments of the present disclosure relate to a method for predicting wastewater treatment performance that changes according to wastewater conditions and membrane contact process conditions in a process of removing ammonia by a membrane contact process, and aims to provide a method for predicting wastewater treatment performance that can accurately calculate an ammonia removal rate according to the conditions.

According to the embodiments, the ammonia removal rate is calculated through a simplified physicochemical and mathematical model, thereby preventing the computer load problem that occurs in performance prediction by conventional computational fluid dynamics (CFD).

In addition, since it is possible to reflect changes in various factors affecting the ammonia removal rate, it is possible to predict an ammonia removal rate with high accuracy that is close to the actual ammonia removal rate.

In addition, by applying the conditions of the various factors mentioned above when the ammonia removal rate is optimized to an actual site, the actual ammonia removal efficiency can be increased.

A method for predicting wastewater treatment performance according to one or more embodiments includes a method for predicting membrane contact process performance of a membrane contact device that removes ammonia contained in wastewater, the method including: inputting the wastewater conditions; inputting membrane contact process conditions of the membrane contact device; and predicting the removal rate of ammonia removed from the wastewater using a prediction model that calculates the removal rate of ammonia, the prediction model including equations using the wastewater conditions and the membrane contact process conditions.

A method for predicting wastewater treatment performance according to one or more embodiments includes a method for predicting membrane contact process performance of a membrane contact device that removes ammonia contained in wastewater, the method including: inputting the wastewater conditions; inputting the membrane contact process conditions of the membrane contact device; calculating the concentration of vaporized ammonia (NH_{3(g)}) in the wastewater moving unit within the membrane contact device; calculating the diffusion flux (J) of the ammonia (NH_{3(g)}) absorbed into the absorption unit through pores of the membrane contact device; calculating the removal rate of ammonia from the mass (m) of the absorbed ammonia; and verifying the calculated ammonia removal rate.

A method for predicting wastewater treatment performance according to one or more embodiments includes a method for predicting membrane contact process performance of a membrane contact device that removes ammonia contained in wastewater, the method including: deriving optimal conditions of the wastewater and optimal conditions of the membrane contact process of the membrane contact device so that the ammonia removal rate from the wastewater becomes an optimal value; supplying the wastewater to the membrane contact device under the optimal wastewater conditions; adjusting the membrane contact process conditions to match the optimal conditions; and verifying the ammonia removal rate calculated using the optimal wastewater conditions and the optimal membrane contact process conditions.

### BRIEF DESCRIPTION OF DRAWINGS

FIG. 1 is a diagram illustrating a wastewater treatment system including a membrane contact process consisting of one stage.

FIG. 2 is a drawing illustrating a membrane contact process within a membrane contact device according to FIG. 1.

FIG. 3 is a drawing illustrating a process for treating ammonia in wastewater.

FIG. 4 is a diagram illustrating a method for predicting wastewater treatment performance according to one or more embodiments.

FIG. 5 is a diagram illustrating a method for predicting wastewater treatment performance according to one or more other embodiment.

FIG. 6 is a diagram illustrating a method for predicting wastewater treatment performance according to one or more other embodiment.

FIG. 7 is a graph predicting the ammonia removal efficiency in wastewater according to the ammonia flow rate and temperature using a method for predicting wastewater treatment performance according to an embodiment.

FIG. 8 is a graph predicting the ammonia removal efficiency in wastewater according to the ammonia flow rate and pH using a method for predicting wastewater treatment performance according to one or more embodiments.

FIG. 9 is a graph predicting ammonia removal efficiency according to ammonia flow rate and ammonia concentration contained in wastewater using a method for predicting wastewater treatment performance according to one or more embodiments.

FIG. 10 is a graph predicting ammonia removal efficiency according to the pore diameter through which wastewater passes and the porosity using a method for predicting wastewater treatment performance according to one or more embodiments.

FIG. 11 is a graph comparing the ammonia removal rate according to the change in ammonia flow rate predicted using a method for predicting wastewater treatment performance according to one or more embodiments of the present disclosure with the ammonia removal rate actually obtained.

FIG. 12 is a graph comparing the ammonia removal rate according to pH change predicted using a method for predicting wastewater treatment performance according to one or more embodiments of the present disclosure with the ammonia removal rate actually obtained.

FIG. 13 is a graph comparing the ammonia removal rate according to temperature change predicted using a method for predicting wastewater treatment performance according to one or more embodiments of the present disclosure with the ammonia removal rate actually obtained.

FIG. 14 is a diagram illustrating a wastewater treatment system including a membrane contact process consisting of three stages.

FIGS. 15A and 15B are graphs predicting the efficiency of ammonia removal in wastewater using a method for predicting wastewater treatment performance in a wastewater treatment process according to a three-step membrane contact process.

FIGS. 16A and 16B are graphs predicting the efficiency of ammonia removal in wastewater using a wastewater treatment performance prediction method in a wastewater treatment process according to a two-step membrane contact process.

FIG. 17 is a graph comparing the ammonia removal rate actually obtained according to wastewater treatment using a three-step membrane contact process and the ammonia removal rate predicted using the wastewater treatment performance prediction method according to the present disclosure.

### DETAILED DESCRIPTION OF EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

To clearly describe the present disclosure, parts that are irrelevant to the description in the drawings are omitted, and like numerals refer to like or similar constituent elements throughout the specification.

Further, since sizes and thicknesses of constituent members shown in the accompanying drawings are arbitrarily given for better understanding and ease of description, the present disclosure is not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

Throughout this specification and the claims that follow, when it is described that an element is “coupled/connected” to another element, the element may be “directly coupled/connected” to the other element or “indirectly coupled/connected” to the other element through a third element. In addition, unless explicitly described to the contrary, the word “comprise” and variations such as “comprises” or “comprising” will be understood to imply the inclusion of stated elements but not the exclusion of any other elements. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

It will be understood that when an element such as a layer, film, region, plate, etc. is referred to as being “on” another element, it can be directly on the other element or intervening elements may also be present. In contrast, when an element is referred to as being “directly on” another element, there are no intervening elements present. Further, in the specification, the word “on” or “above” can mean positioned on or below the object portion, and does not necessarily mean positioned on the upper side of the object portion based on a gravitational direction.

Furthermore, in describing components of embodiments according to the present disclosure, symbols such as first, second, (a), (b), etc. were used. These symbols are only intended to distinguish one component from another, and do not limit the order or sequence of the components.

The technologies for removing low concentrations of ammonia (20 mg/L or less) existing in water include the breakthrough chlorine injection method and the electrochemical oxidation method.

Breakthrough chlorine injection is a chemical method for removing ammonia. This method removes ammonia by injecting chlorine (Cl₂) into a gas or aqueous solution containing ammonia. Chlorine reacts with ammonia to form compounds such as ammonium chloride (NH₄Cl), which reduces ammonia concentration. However, the breakthrough chlorine injection method requires caution when handling due to the toxicity of chlorine, and there is a problem that other additional chemicals are created if excessive chlorine is injected.

The Electrochemical Oxidation Method is a method of oxidizing ammonia using electricity. This method works by passing an electric current through electrodes to oxidize ammonia (NH₃), converting it into nitrogen and water, thus reducing the ammonia concentration. However, the Electrochemical Oxidation Method has the disadvantages that it requires maintenance of electrical equipment and electrodes, the initial installation cost is relatively high, and the efficiency of the system may vary depending on the electrode material and reaction conditions.

Recently, air stripping or scrubber technology has been utilized as a technology to remove high concentrations of ammonia of 100 mg/L or more.

Air stripping is a technology that removes volatile pollutants, including ammonia, from wastewater through air flow. However, there are problems in that it requires a large process site and consumes a large amount of energy.

The scrubber method is a technology that removes vaporized ammonia by absorbing it in water drops containing sulfuric acid. The smaller the droplet size, the greater the surface area available to absorb ammonia. Because of this, a lot of energy is needed to create small droplets and a large space to maintain them.

Accordingly, a technology for recovering ammonia from wastewater through a membrane contact process (MC) is being developed recently.

The membrane contact process is a technology that flows wastewater containing pollutants and an absorbent liquid (sulfuric acid, phosphoric acid, formic acid, etc.) capable of absorbing pollutants through a membrane with hydrophobic pores having a diameter of 100 nm to 1 μm. In this process, the principle of diffusion through the pores of the membrane by volatile contaminants such as ammonia from wastewater to the absorbent solution due to concentration differences is utilized.

The membrane contact process is a technology that combines the advantages of liquid absorption and membrane separation and is a process that takes place within a membrane contact device. The effective surface area for mass transfer can be significantly increased by utilizing hydrophobic hollow fiber membrane bundles in a membrane contact device. In fact, it has the advantage of being able to reduce the size of the unit process by up to 1/10 compared to the existing air stripping.

In order to verify the performance of the membrane contact process, there is a method of observing changes in performance according to operating conditions through actual experiments. However, this method is not very efficient in terms of time and economy.

In particular, the ammonia removal performance by the membrane contact process changes depending on various conditions such as pH, flow rate, and temperature of the wastewater. In addition, the characteristics of the separator, including the material of the separator, pore size distribution, and number of pores, as well as the structural conditions within the membrane contact process, affect the ammonia removal performance. Accordingly, in order to accurately confirm the process performance of the membrane contact process, there is a limitation in predicting performance in that all of the above-mentioned various operating conditions must be confirmed.

Conventional performance prediction methods have been limited to prediction models that predict performance by considering only some of the various conditions listed above.

In order to predict performance by considering all of the various conditions above, there was a problem that a high-performance computer was needed because the computer was overloaded by complex calculations.

Additionally, there is a method to predict performance using computational fluid dynamics (CFD). However, this also made it difficult to apply to actual processes due to computer load issues that made it difficult to check results in real time.

The method for predicting wastewater treatment performance according to the present disclosure is intended to deal with the above difficulties. That is, it relates to a method for accurately predicting the removal rate of ammonia by considering the influence of various conditions in the process of removing ammonia using a membrane contact process.

The present disclosure, unlike the prior art, predicts performance by considering all of the various conditions, thereby accurately predicting an ammonia removal rate, and is characterized in that the performance prediction process is simplified and a prediction model derived from a physicochemical and mathematical model is used to enable rapid prediction, thereby enabling real-time confirmation of results.

Hereinafter, a method for predicting wastewater treatment performance according to one or more embodiments of the present disclosure will be described in more detail with reference to the drawings.

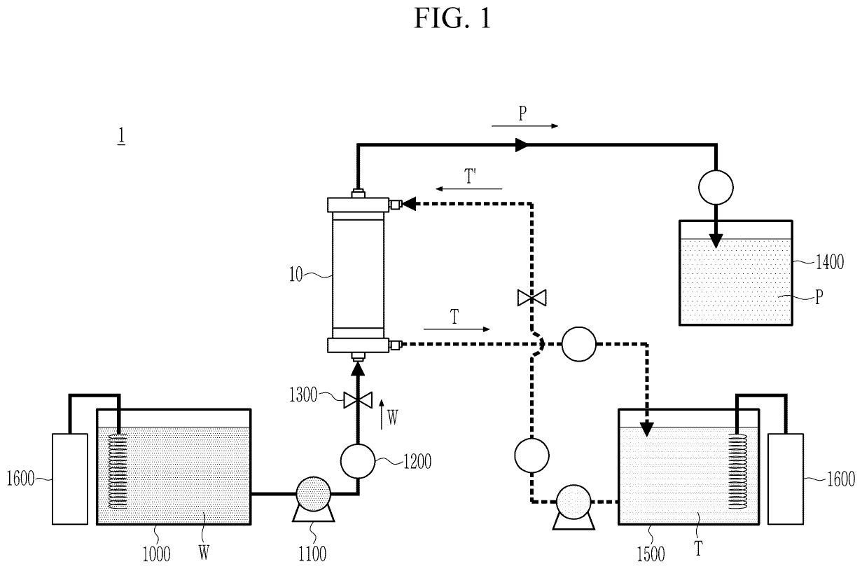

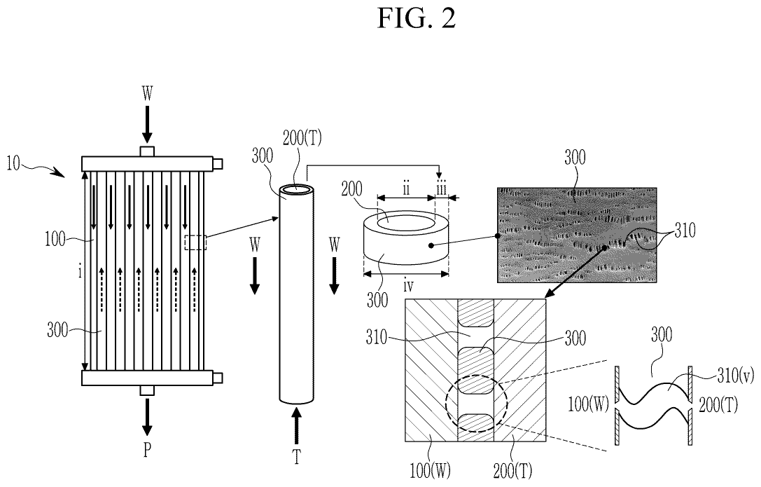

FIG. 1 is a drawing illustrating a wastewater treatment system including a membrane contact process consisting of one stage, and FIG. 2 is a drawing illustrating a membrane contact process performed in a membrane contact device according to FIG. 1.

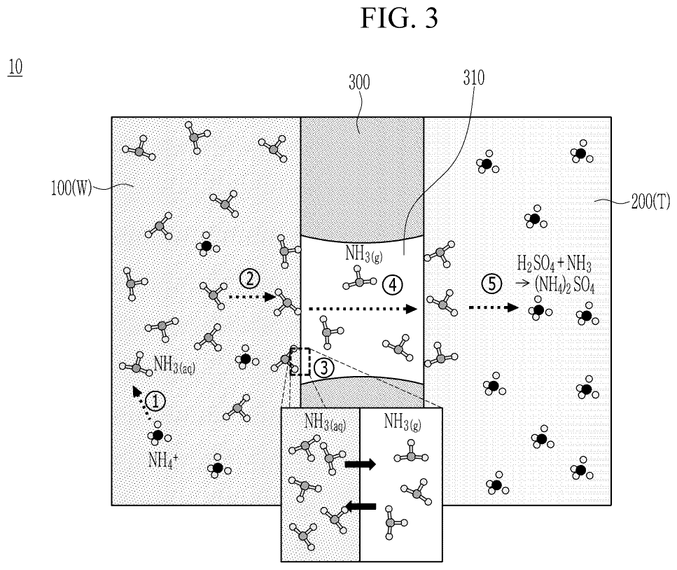

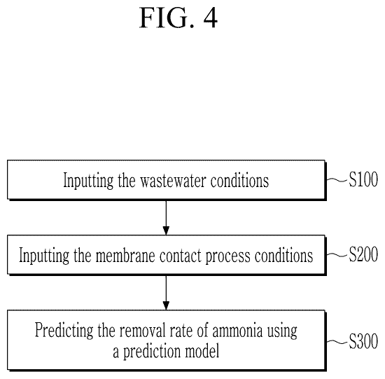

FIG. 3 is a drawing for explaining a process for treating ammonia in wastewater, and FIG. 4 is a drawing for explaining a method for predicting wastewater treatment performance according to one or more embodiments.

In the wastewater treatment system 1 illustrated in FIG. 1, a membrane contact process can be performed by passing through one membrane contact device 10. This is referred to as a one-stage membrane contact device.

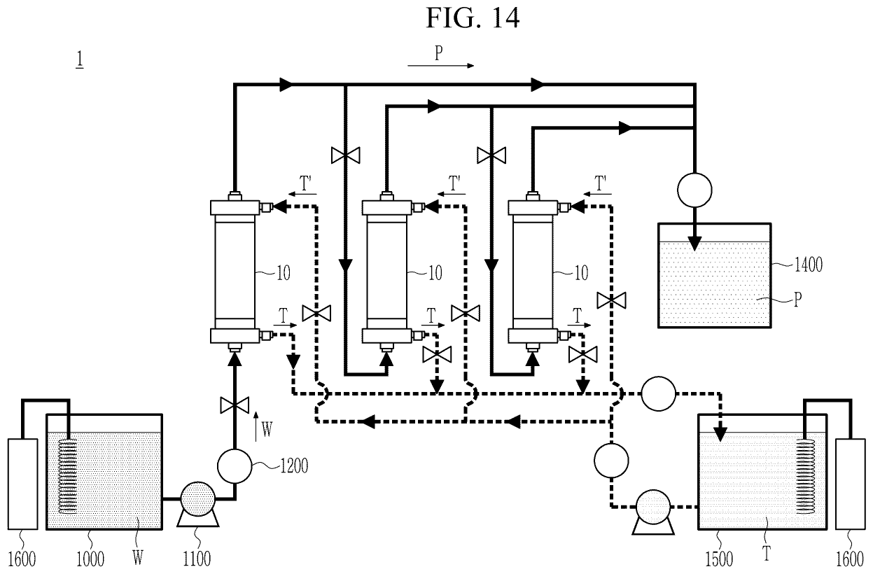

The wastewater treatment system 1 illustrated in FIG. 14 below includes three membrane contact devices 10, which are referred to as a three-stage membrane contact device.

Additionally, although not shown, the wastewater treatment system 1 may include two membrane contact devices 10. This is called a two-stage membrane contact device.

Wastewater (W) supplied from a wastewater storage tank 1000 containing wastewater (W) can be supplied to a membrane contact device 10 by a pump 1100.

A sensor 1200 for measuring pressure and a valve 1300 for controlling the flow rate of wastewater (W) may be placed between the wastewater storage tank 1000 and the membrane contact device 10.

Wastewater (W) can pass through a membrane contact device 10 to become treated water (P). The treated water (P) is the waste water (W) from which ammonia has been removed, and the treated water (P) can be moved to the treated water tank 1400.

The absorbent (T) that has absorbed ammonia and is accommodated in the membrane contact device 10 can be moved to the absorbent tank 1500.

The absorbent (T) that has absorbed ammonia can be heated by a heater 1600 in an absorbent tank 1500 and go through a filtering process to remove ammonia, thereby changing into an absorbent (T′) from which ammonia has been removed. The absorbent (T′) from which ammonia has been removed can move back to the membrane contact device 10 and play a role in absorbing ammonia.

A heater 1600 may be placed in each of the wastewater storage tank 1000 and the absorbent tank 1500. Each heater 1600 can serve to control the temperature of wastewater (W) and absorbent (T).

FIG. 2 is a drawing illustrating a membrane contact process that is performed inside the membrane contact device 10 illustrated in FIG. 1.

FIG. 3 is a drawing illustrating the process of ammonia (NH₃) moving from a wastewater moving unit 100 toward an absorption unit 200 (separator 300).

Referring to FIGS. 2 and 3, the membrane contact device 10 may include the wastewater moving unit 100 through which wastewater (W) moves, the absorption unit 200 disposed along a flow path of the wastewater (W) in the wastewater moving unit 100 for absorbing ammonia from the wastewater, and a separator 300 having a shape surrounding the absorption unit 200.

The absorption unit 200 is placed inside the separator 300 and may have a circular rod shape. However, the shape of the absorption unit 200 is not limited to a circular rod shape.

The absorption unit 200 can play a role in absorbing ammonia from wastewater (W).

An absorbent (T) may be placed in the absorption unit 200. The absorbent (T) contains an acid, and ammonia that has moved to the absorption unit 200 can react with the acid of the absorbent (T) to form a non-volatile compound. In FIG. 3, sulfuric acid is shown as an absorbent (T), but nitric acid, phosphoric acid, formic acid, etc. may be included.

A plurality of absorption units 200 can be arranged within the wastewater moving unit 100 (see FIG. 2). The greater the number of absorption units 200 arranged, the greater the amount of ammonia in the wastewater (W) absorbed by the absorption units 200.

The separator 300 may include a plurality of pores 310. The pore 310 may be a path through which ammonia moves from the wastewater moving unit 100.

Referring to FIG. 3, ammonia (NH_{3(aq)}) in wastewater (W) contained in the wastewater moving unit 100 mostly exists as ammonia (NH_{3(g)}) at high pH. Accordingly, ammonia (NH_{3(g)}) is vaporized through the pores 310 of the separator 300, and it can be confirmed that the vaporized ammonia passes through the pores and moves to the absorption unit 200.

First, ammonia can exist in wastewater (W) in the form of ammonium ion (NH₄_{⁺}) and ammonia (NH_{3(aq)}). At pH 9 or higher, ammonium ion (NH₄_{⁺}) can change into the form of ammonia (NH_{3(aq)}), and at pH 11 or higher, more than 99% exists as ammonia (NH_{3(aq)}) (refer to \textcircled{1}).

After being converted to ammonia at high pH, ammonia (NH_{3(aq)}) in water can change into ammonia (NH_{3(g)}) while moving toward the pores 310 of the separator 300 according to Henry's law. Ammonia gas (NH_{3(g)}) can diffuse toward the pores 310 due to the concentration difference (see \textcircled{2}, \textcircled{3}).

After ammonia (NH_{3(g)}) moves from the pore 310 toward the absorption unit 200 (see \textcircled{4}), the ammonia (NH_{3(g)}) that has moved to the absorption unit 200 can react with the acid (H₂SO₄) of the absorbent (T) contained inside the absorption unit 200 to form a non-volatile compound ((NH₄)₂SO₄) (see \textcircled{5}).

Referring to FIG. 3, the process of removing ammonia in wastewater (W) in a membrane contact process performed in a membrane contact device 10 may include a step in which ammonia (NH_{3(aq)}) is vaporized in a wastewater moving unit 100, a step in which the vaporized ammonia (NH_{3(g)}) diffuses into the pores 310 of a separator 300, and a step in which the diffused ammonia (NH_{3(g)}) is absorbed into an absorption unit 200.

In the method for predicting wastewater treatment performance according to the present disclosure, the ammonia removal rate prediction method can calculate the ammonia removal rate by using the conditions of the wastewater (W) and the membrane contact process conditions of the membrane contact device 10 as variables. In other words, the method for predicting the ammonia removal rate can control the ammonia removal rate by controlling the conditions of the wastewater (W) and the membrane contact process conditions.

The wastewater (W) conditions may include at least one of pH, temperature, flow rate of the wastewater (W), and concentration of ammonia in the wastewater (W).

The condition of wastewater (W) refers to the state value of wastewater (W) moving through the wastewater moving unit 100.

The conditions of the membrane contact process may include at least one of the length (i) of the separator 300, the diameter (ii) of the absorption unit 200, the thickness (iii) of the separator 300, and the area (A) of the separator 300.

The area (A) of the separator 300 refers to the area obtained when all the separators 300 surrounding the absorption unit 200 are spread out. This can be obtained by multiplying the length (i) of the separator 300 by the width over which all separators are spread out.

Depending on the embodiment, the conditions of the membrane contact process may further include at least one of the surface area of the unit separator 300 and the diameter (iv) of the separator 300 surrounding the absorption unit 200. A unit separator 300 means each separator 300 forming a plurality of separators 300 included in a membrane contact device 10.

Depending on the embodiment, the conditions of the membrane contact process may include at least one of the average pore diameter (dₚ), porosity (ε), internal volume (Vₚ), and pore tortuosity (curvature) (τ) of the separator 300.

The internal volume (Vₚ) in the membrane contact device 10 means the value obtained by excluding the volume occupied by the hollow fiber-shaped separator 300 from the total volume. That is, it matches the volume in which the actual wastewater (W) flow occurs in the membrane contact device 10.

The porosity (ε) of the separator 300 represents the ratio of the volume occupied by pores 310 in the unit volume of the separator 300. In the case of a porous membrane with a constant pore size 310, the area occupied by all pores 310 in a unit area of the membrane surface is the same and has a value between 0 and 1.

The conditions of the membrane contact process are explained with reference to FIG. 2.

The length (i) of the separator 300 refers to the length along the longitudinal direction of the separator 300 surrounding the absorption unit 200, i.e., the direction in which the wastewater (W) moves.

In FIG. 2, the diameter (ii) of the absorption unit 200, the thickness (iii) of the separator 300, the diameter (iv) of the separator 300, and the curvature (τ) (v) of the pores 310 are shown. The curvature (v) of the pore 310 refers to the degree of bending of the pore 310.

The thickness (iii) of the separator 300 refers to the distance from the outer surface of the absorption unit 200 to the outer surface of the separator 300 in the state of the separator 300 surrounding the absorption unit 200. This means the L value in the equation below and [Table 1].

Referring to FIG. 4, the method for predicting wastewater treatment performance according to the present disclosure is characterized by including a step (S100) of inputting wastewater (W) conditions, a step (S200) of inputting conditions of a membrane contact process, and a step (S300) of predicting the removal rate of ammonia removed from wastewater (W) using a prediction model in which the removal rate of ammonia is calculated according to the wastewater (W) conditions and the membrane contact process conditions.

In order to explain the process of calculating the ammonia removal rate according to the wastewater (W) conditions and membrane contact process conditions, the ammonia removal process will be described in detail with reference to FIG. 3.

First, the step in which ammonia (NH_{3(aq)}) is vaporized in the wastewater moving unit 100 may include a process in which ammonia (NH_{3(aq)}) among the ammonium ions (NH₄_{⁺}) and ammonia (NH_{3(aq)}) present in the wastewater (W) is changed into ammonia (NH_{3(g)}) (see \textcircled{1}, \textcircled{2}, and \textcircled{3} of FIG. 3).

Next, a step is performed in which vaporized ammonia (NH_{3(g)}) diffuses into the pores 310 of the separator 300 (see \textcircled{3} of FIG. 3). At this stage, the concentration of ammonia (NH_{3(g)}) diffusing into the pores 310 can be calculated using the concentration of ammonia (NH_{3(aq)}) in the wastewater (W), the pH of the wastewater (W), and the temperature as variables.

First, the concentration of ammonia [NH_{3(aq)}] in wastewater (W) calculated using the prediction model according to the present disclosure can be calculated using equations (1) to (3) as follows.

$$[ {C}_{0} ] = [ {NH}_{{4}^{+} ( aq )} ] + [ {NH}_{3 ( aq )} ] \qquad ( 1 )$$

$${K}_{a} = \frac{[ {NH}_{3 ( a q )} ] * [ {H}^{+} ]}{[ {NH}_{4 ( a q )}^{+} ]} \qquad ( 2 )$$

$$[ {NH}_{3 ( a q )} ] = \frac{[ {C}_{0} ] * {K}_{a}}{[ {H}^{+} ] + {K}_{a}} \qquad ( 3 )$$

[C₀] refers to the total molar concentration of ammonia in the wastewater (W) contained in the wastewater moving unit 100, which can be calculated as the sum of the molar concentration of ammonium ion (NH₄_{⁺}) and the molar concentration of ammonia (NH_{3(aq)}) (equation (1)).

The concentration of ammonia in wastewater (W) changes form depending on pH and can be calculated using the acid dissociation constant Kₐ (equation (2)).

The concentration of ammonia (NH_{3(aq)}) in wastewater (W) can be calculated using equation (3).

Here, the acid dissociation constant Kₐ can be affected by the wastewater (W) temperature (T), as in Equation (4) below (Licon et al., 2015; Montes et al., 2009).

$${K}_{a} = 1 {0}^{0.05 - ( \frac{2788}{T} )} \qquad ( 4 )$$

As a result, it means that the concentration of ammonia [NH_{3(aq)}] changes depending on the temperature (T) and pH of the wastewater (W).

Next, the step in which vaporized ammonia (NH_{3(g)}) diffuses into the pores 310 of the separator 300 may include a process in which air and ammonia (NH_{3(g)}) present in the pores 310 reach equilibrium. Specifically, it can be explained that thermodynamic equilibrium is achieved according to Henry's law.

The pores 310 of the initial separator 300 are not saturated with ammonia (NH_{3(g)}). Accordingly, a concentration difference exists between the ammonia (NH_{3(g)}) in the wastewater moving unit 100 and the ammonia (NH_{3(g)}) in the pores 310. According to the law of diffusion, ammonia (NH_{3(g)}) moves from areas of high concentration to areas of low concentration.

In this process, the curvature (T) of the pore 310 and the diameter (dₚ) of the pore 310 have an effect.

The concentration of ammonia [NH_{3(g)}] in equilibrium within the pore 310, calculated using the prediction model according to the present disclosure, can be calculated as follows.

$${P}_{{NH}_{3 ( g )}} = {K}_{h} * [ {NH}_{3 ( a q )} ] \qquad ( 5 )$$

$$ln ( {K}_{h} ) = - ( \frac{4092}{T} - 9.7 ) \qquad ( 6 )$$

$$[ {NH}_{3 ( g )} ] = \frac{{P}_{{NH}_{3 ( g )}}}{R * T} \qquad ( 7 )$$

In Equation (5), the partial pressure (P_{NH3(g)}) of ammonia (NH_{3(g)}) can be calculated using Henry's constant (Kₕ) at a specific temperature and the ammonia concentration [NH_{3(aq)}].

As in Equation (6), Henry's constant (Kₕ) is a constant that varies with temperature (Renard et al., 2004).

According to the P_{NH3(g)} value calculated using the equations (5) and (6), the concentration of ammonia [NH_{3(g)}] can be calculated using the ideal gas law (Equation (7)).

Next, the step in which diffused ammonia (NH_{3(g)}) is absorbed into the absorption unit 200 may include a step in which ammonia (NH_{3(g)}) that has reached equilibrium within the pores 310 moves from the pores 310 toward the absorption unit 200 (see \textcircled{4} of FIG. 3).

In addition, a step may be included in which ammonia (NH_{3(g)}) that has moved to the absorption unit 200 reacts with an acid contained inside the separator 300 to form a non-volatile compound (see \textcircled{5} of FIG. 3).

The diffusion flux (J) of ammonia (NH_{3(g)}) absorbed into the absorption unit 200, calculated using the prediction model according to the present disclosure, can be calculated as follows.

First, to model the movement of ammonia (NH_{3(g)}) molecules through the pores 310, Fick's first law can be used (Equation (8)) (Won et al., 2019).

$$J = - D \frac{\partial C}{\partial x} \qquad ( 8 )$$

Fick's first law is a law that states that the concentration gradient

$$\frac{\partial C}{( \partial x )}$$

is directly proportional to the x-coordinate of the diffusion flux (J).

The diffusion coefficient (D) refers to a coefficient representing the diffusion speed of ammonia (NH_{3(g)}) within the pores 310. The diffusion coefficient (D) can be calculated using the Dₖ and Dₘ values, as in Equation (11) below.

The diffusion mechanism in the present disclosure can be achieved by at least one of Knudsen diffusion and molecular diffusion (Jiang et al., 2022; Khayet 2008).

Here, the diffusion coefficient (D) can be calculated using equations (9) to (11) as follows. Dₖ is the diffusion coefficient of Knudsen diffusion, and Dₘ is the diffusion coefficient of molecular diffusion. Dₖ and Dₘ can be calculated using equations (9) and (10) below (Agrahari et al., 2012; Jozsef et al., 2020).

$${D}_{k} = \frac{2}{3} * {d}_{p} * v \qquad ( 9 )$$

$${D}_{m} = \frac{1}{3} * v * λ \qquad ( 10 )$$

$$\frac{1}{D} = \frac{T}{ε} * ( \frac{1}{{D}_{k}} + \frac{1}{{D}_{m}} ) \qquad ( 11 )$$

The diffusion mechanism may vary depending on the mean free path (λ) along which ammonia gas (NH_{3(g)}) molecules move without colliding with other gas molecules and the diameter (dₚ) of the pores 310 of the separator 300.

Knudsen diffusion applies when dₚ<0.1λ. In the case of 0.1λ<dₚ<100λ, both Knudsen diffusion and molecular diffusion can be dominantly applied. When dₚ>100λ, molecular diffusion can be applied to explain mass transfer within the pores 310.

v in equations (9) and (10) can be calculated through equation (12) below.

$$ν = \sqrt{\frac{8 * R * T}{π * M}} \qquad ( 12 )$$

M is the molar mass of ammonia (NH_{3(g)}) converted to kilogram units (kg/mol). R stands for the gas constant (8.314 J/molK) and T stands for absolute temperature.

The mean free path (λ) in equation (10) can be calculated through equation (13) below.

$$λ = \frac{{k}_{B} T}{\sqrt{2} π {η}^{2} {P}_{g}} \qquad ( 13 )$$

Here, k_{B} is the Boltzmann constant (1.3806×10⁻²³ J/K).

The η value is the kinetic diameter of ammonia (NH_{3(g)}) (260×10⁻¹² m), and P_{g} represents the gas pressure (10⁵ Pa).

D in equation (11) can be expressed as the effective pore diffusion coefficient and can be calculated using Dₖ and Dₘ (Aligwe et al. 2020; Agrahari et al. 2012).

By rearranging the above equation (substituting equation (11) into equation (8)), the diffusion flux (J) of ammonia (NH_{3(g)}) moving to the absorption unit 200 calculated using the prediction model according to the present disclosure can be calculated using equation (14) below.

$$J = \frac{D * ε}{T} * \frac{( [ {NH}_{3 ( g )} ] )}{L} \qquad ( 14 )$$

The above equation (14) is an equation that assumes that all ammonia (NH_{3(g)}) molecules move across the separator 300 from the wastewater moving unit 100 to the absorption unit 200. All ammonia (NH_{3(g)}) is assumed to move across the thickness (L) of the separator 300.

In addition, the equation assumes that the final concentration of ammonia (NH_{3(g)}) at the boundary between the separator 300 and the absorption unit 200 is 0.

In the above equation (14), the ε value represents the porosity of the separator 300, and the τ value represents the tortuosity of the pores.

The mass (m) of ammonia absorbed in the absorption unit 200 calculated using the prediction model according to the present disclosure can be calculated using the following equation (15).

$$m = J * t * A * ε \qquad ( 15 )$$

The mass (m) of ammonia absorbed in the absorption unit 200 can be calculated by multiplying the diffusion flux (J) of ammonia (NH_{3(g)}), the hydraulic retention time (t), the total area (A) of the separator 300, and the porosity (ε) of the separator 300.

That is, the mass (m) of ammonia absorbed in the absorption unit 200 can vary depending on the diffusion flux (J) of ammonia (NH_{3(g)}), the hydraulic retention time (t), the area (A) of the entire separator 300, and the porosity (ε).

The method for predicting the ammonia removal rate according to the present disclosure can be calculated using the mass of ammonia absorbed into the absorption unit 200 through the pores 310.

Specifically, the length (i) of the separator 300 is divided into n segments, and then the mass (m) of ammonia absorbed in one segment and the volume of the treated wastewater (W) are used to calculate the concentration of ammonia discharged in the treated water (P). Next, this can be used in feedback calculations to calculate the ammonia removal rate of the next segment.

Here, the volume of treated wastewater (W) can be defined as the product of the flow rate of wastewater (W) and the operating time of the membrane contact process.

The equation for calculating the ammonia removal rate in each segment can be calculated using equations (16) and (17) below.

$${C}_{n} + \frac{m}{shell side volume / n} \qquad ( 16 )$$

$$Removal efficiency ( \% ) = \frac{( {C}_{i n i tial} - {C}_{final} )}{{C}_{i n i t i a l}} \times 100 \qquad ( 17 )$$

n refers to the nth segment when cut along a plane perpendicular to the direction in which wastewater (W) moves in the wastewater moving unit 100. Cₙ represents the concentration of ammonia in compartment n.

In equation (16), m represents the mass (m) of ammonia, and the internal volume (Vₚ, shell side volume) represents the volume (total volume−volume occupied by the separator) through which wastewater (W) can flow within the membrane contact device 10 (see [Table 1] below). By dividing the internal volume (Vₚ) by the flow rate of wastewater (W), the hydraulic retention time (t) of the wastewater (W) within the entire membrane contact device 10 can be determined.

In equation (17), the ammonia removal efficiency can be obtained by calculating the difference between the initial ammonia concentration (Cᵢₙᵢₜᵢₐₗ) and the ammonia concentration in the treated water (C_{final}), and then dividing this difference by the initial ammonia concentration (Cᵢₙᵢₜᵢₐₗ).

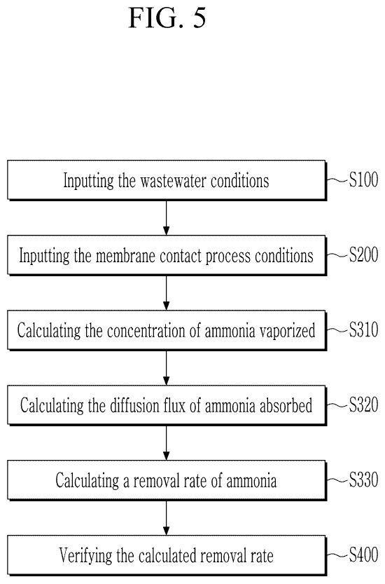

FIG. 5 is a diagram illustrating a method for predicting wastewater treatment performance according to one or more other embodiment.

According to one or more other embodiment, a method for predicting wastewater treatment performance is a method for predicting the membrane contact process performance of a membrane contact device 10 that removes ammonia contained in wastewater (W), and may include a step of inputting wastewater conditions (S100), a step of inputting membrane contact process conditions of the membrane contact device 10 (S200), a step of calculating the concentration of ammonia (NH_{3(aq)}) vaporized in a wastewater moving unit 100 in the membrane contact device 10 (S310), a step of calculating a diffusion flux (J) of ammonia (NH_{3(g)}) absorbed from a pore 310 in the membrane contact device 10 into an absorption unit 200 (S320), a step of calculating a removal rate of ammonia from a mass (m) of the absorbed ammonia (NH_{3(g)}) (S330), and a step of verifying the calculated removal rate (S400).

The step (S400) of verifying the calculated removal rate is to verify the ammonia removal rate predicted by the wastewater treatment performance prediction method.

The step (S400) of verifying the removal rate may include a step of calculating the concentration of ammonia in the treated water (P) discharged from the membrane contact device 10, a step of comparing the concentration of ammonia in the treated water (P) and the concentration of ammonia in the waste water (W) to derive an actual ammonia removal rate, and a step of comparing the actual ammonia removal rate with the calculated ammonia removal rate.

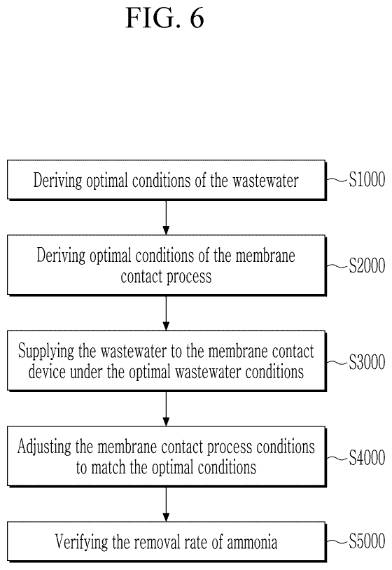

FIG. 6 is a diagram illustrating a method for predicting wastewater treatment performance according to one or more other embodiment.

According to one or more other embodiment, a method for predicting wastewater treatment performance is provided, which is a method for predicting the performance of a membrane contact process in a membrane contact device 10 that removes ammonia contained in wastewater (W), wherein the method may include a step (S1000) of deriving optimal conditions of the wastewater (W) so that the ammonia removal rate from the wastewater (W) becomes an optimal value, a step (S2000) of deriving optimal conditions of the membrane contact process of the membrane contact device 10, a step (S3000) of supplying the wastewater (W) to the membrane contact device 10 under the optimal wastewater conditions, a step (S4000) of adjusting the membrane contact process conditions to match the optimal conditions, and a step (S5000) of verifying the removal rate of ammonia calculated using the optimal conditions of the wastewater and the optimal conditions of the membrane contact process.

The wastewater (W) conditions may include at least one of wastewater (W) pH, temperature, flow rate, and concentration of ammonia in the wastewater (W).

The conditions of the membrane contact process may include at least one of the internal volume, the area, length, thickness, diameter of the separator 300 surrounding the absorption unit 200, and the diameter of the absorption unit 200.

In FIGS. 5 and 6, the description of each step and the description of the process by which ammonia is removed overlap with the description of FIGS. 1 to 4, and thus, a detailed description thereof has been omitted.

In the above, a method for predicting the removal rate of ammonia in wastewater (W) using a method for predicting wastewater treatment performance according to the present disclosure is described.

Below, the results of a verification experiment to determine the accuracy of the removal rate predicted by the method for predicting wastewater treatment performance according to the present disclosure are described.

First, in order to verify the ammonia removal rate predicted by the method for predicting wastewater treatment performance according to the present disclosure, an experiment was conducted under the conditions shown in [Table 1] below.

TABLE 1

| Parameters | Symbol | Value |
|---|---|---|
| total separator area (m²) | A | 1.4 |
| separator length (m) | I | 0.15 |
| separator thickness (μm) | L | 14 |
| absorption unit diameter (μm) | d_{fiber} | 240 |
| separator pore diameter (nm) | dₚ | 60.1 |
| separator porosity | ε | 0.1 |
| internal volume | Vₚ | 0.22 |
| pore tortuosity | τ | 1.54 |
| pH | pH | 9-12 |
| temperature (° C.) | T | 20-50 |
| flow rate (L/h) | Q | 10-100 |
| initial NH₃ concentration (mg/L) | [C₀] | 500-3000 |

The internal volume (Vₚ) of the separator 300 was determined by measuring the weight before and after the experiment after a sufficient amount of time had elapsed and deionized water (DIW) was flowed through the wastewater (W) in the membrane contact device 10 until no more gas was emitted from the membrane contact device 10.

The wastewater (W) used as the experimental subject was an ammonia aqueous solution with ammonium chloride (NH₄Cl) added to deionized water.

The wastewater (W) was allowed to flow along the wastewater moving unit 100 of the membrane contact device 10. In the absorption unit 200, a 0.5 M solution of sulfuric acid (H₂SO₄) or phosphoric acid was supplied as an absorbent (T) using a pump. The absorbent (T) was supplied so as to flow in the opposite direction to the wastewater (W) (see FIG. 2).

The conditions of the membrane contact process were adjusted to match the parameters described in [Table 1] above.

The conditions of wastewater (W) were pH 11, temperature 30° C., flow rate 30 L/h, and initial ammonia concentration 600 mg/L for the experiment.

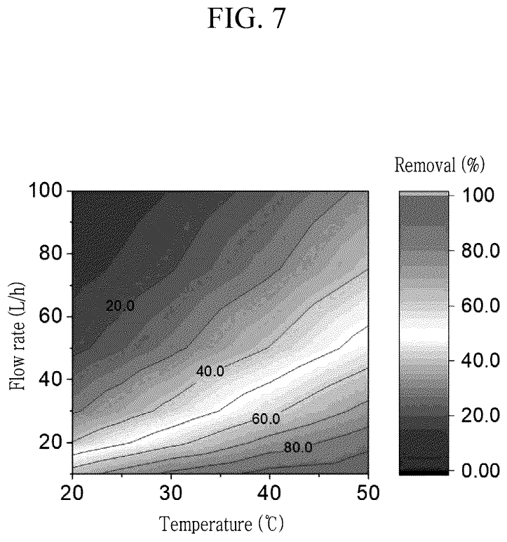

The graphs of FIGS. 7 to 13 described below are experimental graphs performed under the conditions of [Table 1]. The pH was adjusted using 1.0 M H₂SO₄ and 1.0 M NaOH solutions.

FIG. 7 is a graph predicting the ammonia removal efficiency in wastewater according to the ammonia flow rate and temperature using a method for predicting wastewater treatment performance according to an embodiment.

FIG. 7 shows a function according to ammonia flow rate and temperature, and predicts the ammonia removal rate using a wastewater treatment system 1 including a membrane contact device 10 consisting of one stage, as in FIG. 1. As shown in [Table 1], the conditions of the membrane contact process were maintained, and the experiment was conducted with the conditions of wastewater (W) at pH 11 and an initial ammonia concentration of 600 mg/L. As a result of checking the ammonia removal rate while changing the temperature and flow rate among the conditions of wastewater (W), it was confirmed that the ammonia removal rate was higher when the temperature was higher and the flow rate was lower.

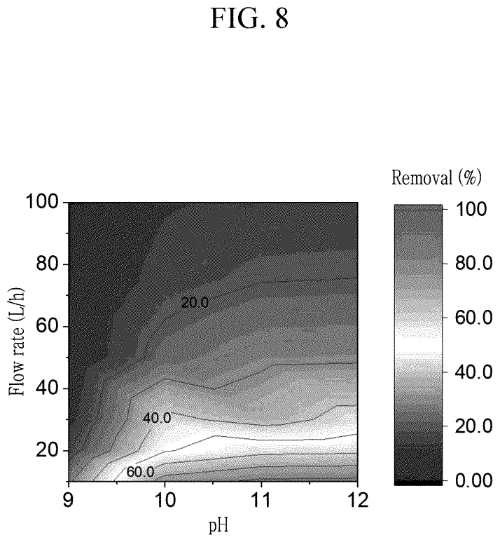

FIG. 8 is a graph predicting the ammonia removal efficiency in wastewater according to the ammonia flow rate and pH using a method for predicting wastewater treatment performance according to one or more embodiments. The conditions of the membrane contact process described in [Table 1] were maintained, and the experiment was conducted with the wastewater (W) conditions of temperature 30° C. and initial ammonia concentration 600 mg/L. As a result of checking the ammonia removal rate while changing the pH and flow rate among the conditions of wastewater (W), it was confirmed that the higher the pH and the smaller the flow rate, the higher the ammonia removal rate.

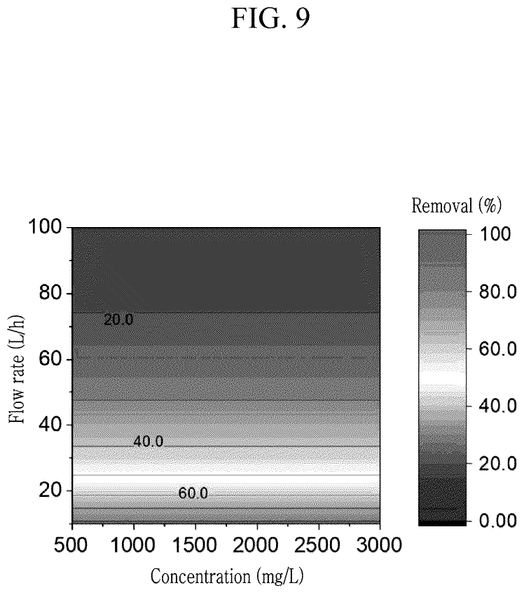

FIG. 9 is a graph predicting the efficiency of ammonia removal in wastewater according to the ammonia flow rate and the concentration of ammonia contained in the wastewater, using a method for predicting wastewater treatment performance according to one or more embodiments. The conditions of the membrane contact process described in [Table 1] were maintained, and the experiment was conducted with the wastewater (W) conditions of pH 11 and temperature 30° C. As a result of checking the ammonia removal rate while changing the initial ammonia concentration and flow rate among the conditions of wastewater (W), it was confirmed that the ammonia removal rate was higher when the flow rate was smaller, regardless of the initial ammonia concentration.

Looking at FIGS. 7 to 9, it can be seen that the ammonia removal rate decreases as the wastewater (W) flow rate increases from 10 L/h to 100 L/h when other conditions are kept constant. This phenomenon can be seen as being related to the hydraulic retention time (t) of the wastewater (W) flow supplied into the membrane contact device 10 (Equation (15)).

Referring to FIG. 7, it can be confirmed that the ammonia removal rate increases as the temperature increases. This may be due to the increase in free ammonia in wastewater (W) at high temperatures and the increase in diffusion coefficient. As can be seen in FIG. 7, the ammonia removal efficiency reaches 28.89% at 20° C. and increases to 73.18% at 50° C.

Increasing the pH of wastewater (W) from 9.0 to 12.0 can accelerate ammonia mass transfer by promoting the dissociation equilibrium of ammonia toward free ammonia. However, it can be confirmed that the trend of increasing free ammonia in wastewater (W) becomes gradual from pH 10.0 or higher, and the increase rate of ammonia removal efficiency decreases (see FIG. 8).

In FIG. 9, the effect of changes in the initial ammonia concentration from 500 mg/L to 3000 mg/L on the ammonia removal rate can be confirmed. That is, the initial ammonia concentration does not affect the ammonia removal rate. Therefore, even if the initial ammonia concentration is changed, the total ammonia removal rate, i.e., the recovery rate, does not change.

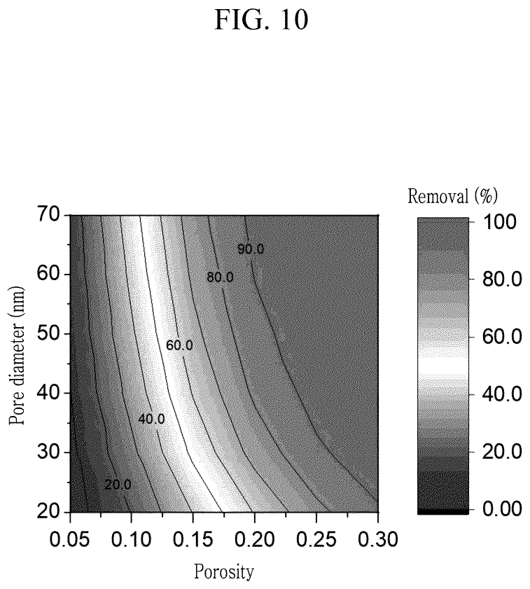

FIG. 10 is a graph predicting ammonia removal efficiency according to the pore diameter through which wastewater passes and the porosity of the separator, using a method for predicting wastewater treatment performance according to one or more embodiments.

The experiment in FIG. 10 was also conducted under the conditions of wastewater (W) described in [Table 1]: pH 11, temperature 30° C., flow rate 30 L/h, and initial ammonia concentration 600 mg/L.

Among the conditions of the membrane contact process, the ammonia removal rate was confirmed while changing the separator pore diameter (dₚ) and the porosity (ε) of the separator. As a result, it was confirmed that the larger the separator pore diameter (dₚ) and the larger the separator porosity (ε), the higher the ammonia removal rate. However, changes in the separator pore diameter (dₚ) do not appear to have a significant effect on the ammonia removal rate.

The characteristics of the separator 300 are a dominant factor in the mechanism by which ammonia (NH_{3(g)}) diffuses through the pores 310, and are a factor that significantly affects the ammonia removal efficiency.

In order to identify the mass transfer mechanism within the pore 310, the mean free path (λ) of ammonia (NH_{3(g)}) can be calculated using equation (13) (λ=1.40×10⁻⁷ m).

Under the condition of 0.1λ<dₚ<100λ, both Knudsen diffusion and molecular diffusion dominate. The mass transfer equations for the two diffusion mechanisms can be found through equations (9) to (14).

FIG. 10 shows an analysis of the effect of the pore diameter (dₚ) of the separator 300 and the porosity (ε) of the separator 300 on the ammonia removal efficiency. In general, it can be confirmed that the separator 300 with a larger pore 310 size and a larger porosity (ε) of the separator has a higher mass transfer coefficient. This results in reducing the resistance to mass transfer and increasing the ammonia removal rate.

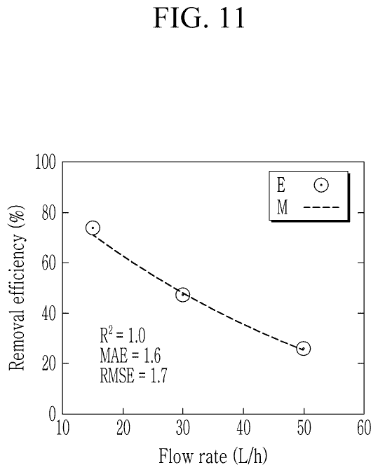

FIGS. 11 to 13 predict the ammonia removal rate using a wastewater treatment system 1 including a membrane contact device 10 consisting of one stage, as in FIG. 1. The experiment was conducted by fixing the conditions, excluding the variables that were changed, to the conditions described in [Table 1].

The graph shows ammonia removal rate data (M) predicted according to the method for predicting wastewater treatment performance according to the present disclosure and actual experimental data (E).

Actual experimental data (E) can be produced through a step of calculating the concentration of ammonia in the treated water (P) discharged from the membrane contact device 10, and a step of deriving the actual ammonia removal rate by comparing the concentration of ammonia in the treated water (P) with the concentration of ammonia in the waste water (W).

FIG. 11 is a graph comparing the ammonia removal rate according to the change in flow rate predicted using a method for predicting wastewater treatment performance according to one or more embodiments of the present disclosure with the ammonia removal rate actually obtained. That is, FIGS. 11 to 13 can be viewed as graphs for comparing the actual ammonia removal rate (E) and the ammonia removal rate (M) calculated according to the present disclosure.

As illustrated, the similarity (R²) between the ammonia removal rate data (M) predicted by the wastewater treatment performance prediction method according to the present disclosure and the actual experimental data (E) is 1.0.

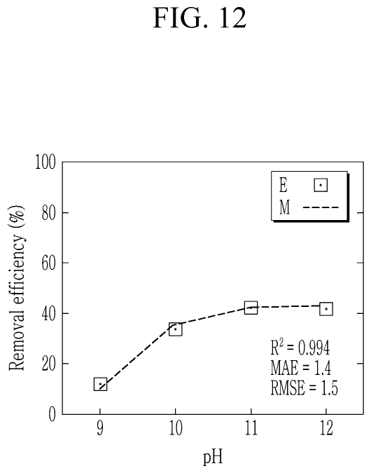

FIG. 12 is a graph comparing the ammonia removal rate according to pH change predicted using a method for predicting wastewater treatment performance according to one or more embodiments of the present disclosure with the ammonia removal rate actually obtained.

As shown, the similarity (R²) between the ammonia removal rate data (M) predicted by the wastewater treatment performance prediction method according to the present disclosure and the actual experimental data (E) is 0.994.

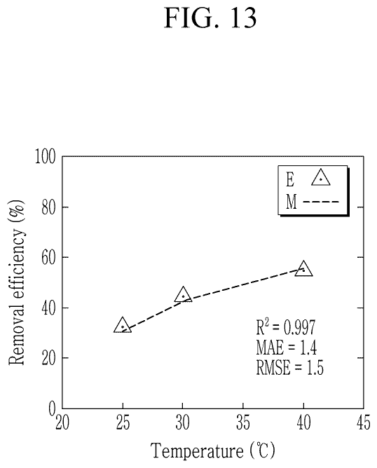

FIG. 13 is a graph comparing the ammonia removal rate according to temperature change predicted using a method for predicting wastewater treatment performance according to one or more embodiments of the present disclosure with the ammonia removal rate actually obtained.

As shown, the similarity (R²) between the ammonia removal rate data (M) predicted by the wastewater treatment performance prediction method according to the present disclosure and the actual experimental data (E) is 0.997.

As can be confirmed through FIGS. 11 to 13, it can be seen that the ammonia removal rate data (M) predicted by the method for predicting wastewater treatment performance according to the present disclosure is almost identical to the actual experimental data (E), which is the result obtained through an actual experiment.

In FIGS. 11 to 13, three fitness indices including coefficient of determination (R²), mean absolute error (MAE), and root-mean-square error (RMSE) are displayed to determine the fitness of data of a model according to the present disclosure. Each indicator can be calculated using the following equations (18) to (20).

$${R}^{2} = \sqrt{\frac{( \sum x * y ) - ( \sum x ) * ( \sum y )}{\sqrt{( N * \sum {x}^{2} - {( \sum x )}^{2} ) * ( N * \sum {y}^{2} - {( \sum y )}^{2} )}}} \qquad ( 18 )$$

$$MAE = \frac{\sum \vert x - y \vert}{N} \qquad ( 19 )$$

$$RMSE = \sqrt{\frac{\sum {( x - y )}^{2}}{N}} \qquad ( 20 )$$

Here, N is the number of data, and x and y represent the actual and predicted values, respectively.

The closer the R² value is to 1, the higher the accuracy of the prediction method according to the present disclosure.

The smaller the MAE and RMSE values, the smaller the prediction error and the closer the agreement between the predicted values and the actual values.

The predicted results for the effects of the flow rate, pH, and temperature of wastewater (W) on the ammonia removal rate are almost identical to the experimental results, as shown in FIGS. 11 to 13. That is, since the R² value is close to 1.0, it can be seen that the accuracy and validity of the predicted value according to the prediction method according to the present disclosure have been proven.

Additionally, the values of MAE and RMSE show relatively low errors, with the error between the predicted value and the actual value being less than 2.0%.

As a result, it can be confirmed that the performance prediction method according to the present disclosure has the reliability and efficiency to accurately predict the ammonia removal rate under various conditions through three suitability indices.

Using the method for predicting wastewater treatment performance according to the present disclosure, which has proven reliability and efficiency, the operating parameters of a wastewater treatment system 1 including a membrane contact device 10 can be designed. Specifically, it is expected that by designing parameters (wastewater conditions and membrane contact process conditions) to optimize performance and operating the wastewater treatment system 1, it will be possible to contribute to achieving the ultimate performance goal.

FIG. 14 is a diagram illustrating a wastewater treatment system including a membrane contact device consisting of three stages. Referring to FIG. 14, a wastewater treatment system 1 is illustrated in which a plurality of membrane contact devices 10 are included.

The membrane contact device 10 included in the wastewater treatment system 1 of FIG. 14 is connected. By means of a plurality of membrane contact devices 10 connected in this way, the wastewater treatment performance, i.e., the ammonia removal performance, can be improved.

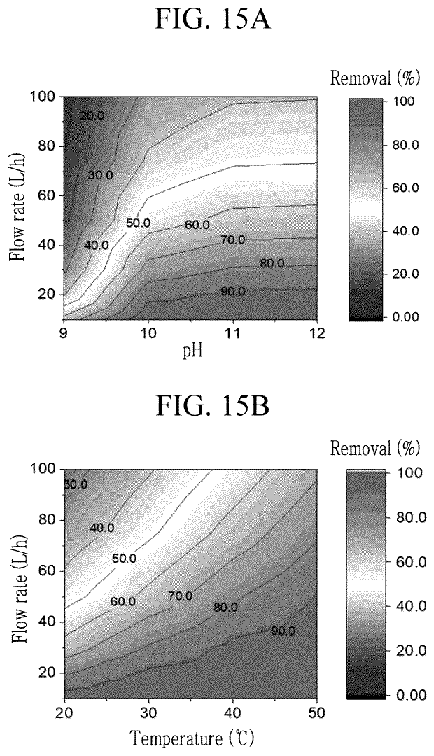

FIGS. 15A and 15B are graphs predicting the efficiency of ammonia removal in wastewater using a wastewater treatment performance prediction method in a wastewater treatment process according to a membrane contact device consisting of three stages as in FIG. 14.

FIG. 15A is a graph predicting the ammonia removal efficiency in wastewater according to the ammonia flow rate and pH, and FIG. 15B shows a function according to the ammonia flow rate and temperature.

In FIG. 15A, the conditions of the membrane contact process described in [Table 1] were maintained, and the experiment was conducted with the wastewater (W) conditions of a temperature of 30° C. and an initial ammonia concentration of 600 mg/L. As a result of checking the ammonia removal rate while changing the pH and flow rate among the conditions of wastewater (W), it was confirmed that the ammonia removal rate was higher when the pH was higher and the flow rate was lower.

In FIG. 15B, the conditions of the membrane contact process described in [Table 1] were maintained, and the experiment was conducted with the conditions of wastewater (W) as pH 11 and an initial ammonia concentration of 600 mg/L. As a result of checking the ammonia removal rate while changing the temperature and flow rate among the conditions of wastewater (W), it was confirmed that the ammonia removal rate was higher when the temperature was higher and the flow rate was lower.

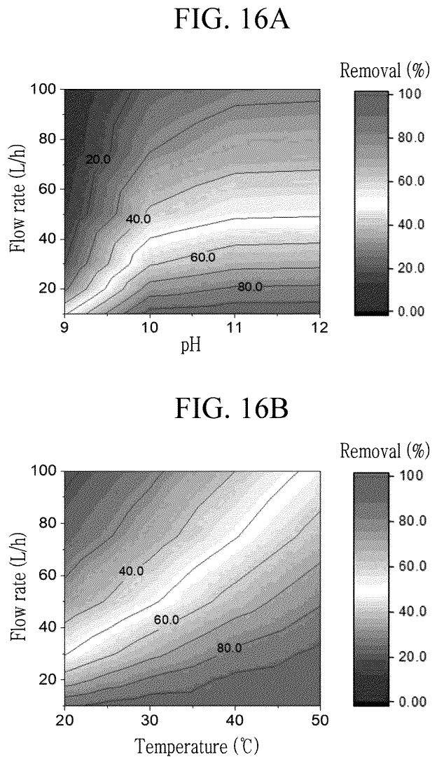

FIGS. 16A and 16B are graphs predicting the efficiency of ammonia removal in wastewater using a method for predicting wastewater treatment performance in a wastewater treatment process using a two-stage membrane contact device.

FIG. 16A is a graph predicting the ammonia removal efficiency in wastewater according to the ammonia flow rate and pH, and FIG. 16B shows a function according to the ammonia flow rate and temperature.

As in FIGS. 15A and 15B, the ammonia removal rate was confirmed by changing the pH and flow rate among the conditions of wastewater (W), and it was confirmed that the higher the pH and the smaller the flow rate, the higher the ammonia removal rate (FIG. 16A). Additionally, it can be confirmed that the higher the temperature and the smaller the flow rate, the higher the ammonia removal rate (FIG. 16B).

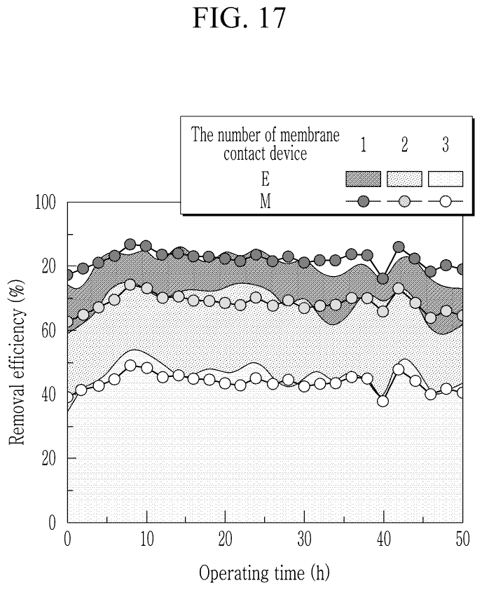

FIG. 17 is a graph comparing the ammonia removal rate actually obtained by wastewater treatment according to a membrane contact device consisting of three stages as in FIG. 14 with the ammonia removal rate predicted using the wastewater treatment performance prediction method according to the present disclosure.

Unlike in the previous experiments, for FIG. 17, an experiment was conducted using actual wastewater. The composition of the actual wastewater used in the experiment is as shown in Table 2.

TABLE 2

| Parameters | Unit | Value |
|---|---|---|
| NH₃—N | mg/L | 741.5 ± 81.2 |
| NO₃_{^{−}}—N | mg/L | 1.61 ± 0.15 |
| NO₂_{^{−}}—N | mg/L | 1.83 ± 0.41 |
| Alkalinity (as CaCO₃) | mg/L | 3148 ± 394 |
| COD | mg/L | 29.37 ± 6.10 |
| SS | mg/L | 9.75 ± 5.12 |
| Conductivity | μS/cm | 575 ± 31.57 |
| pH | | 10.8 ± 0.5 |

The experiment was conducted by adjusting the conditions of the membrane contact process to the optimal conditions for the membrane contact process, which are conditions that can maximize the ammonia removal rate.

The conditions of wastewater (W) were the optimal conditions for wastewater, i.e., pH 11±0.5, temperature 30±2° C., flow rate 30 L/h, and initial ammonia concentration 901±98 mg/L.

The graph illustrated in FIG. 17 shows ammonia removal rate data (M) predicted according to the method for predicting wastewater treatment performance according to the present disclosure and actual experimental data (E).

As shown in FIG. 17, in the wastewater treatment process using a membrane contact device 10 consisting of three stages, an excellent ammonia removal rate can be confirmed, and the overall performance can be confirmed to exceed 80%.

In particular, it can be confirmed that the range of change in the ammonia removal rate is not large. The slight change in removal rate confirmed on the graph is believed to be due to changes in temperature (±2° C.) and pH (±0.5) during the experiment.

In conclusion, it can be confirmed that the performance prediction value (M) according to the present disclosure is almost identical to the actual experimental value (E), and from this, the validity and accuracy of the method for predicting the ammonia removal rate according to the present disclosure can be confirmed again.

Further, one or more embodiments of the present disclosure provide a wastewater treatment system including a membrane contact device, wherein the membrane contact device includes: a wastewater moving unit through which the wastewater moves, an absorption unit disposed along a flow path of the wastewater in the wastewater moving unit, for absorbing ammonia from the wastewater, and a separator having a shape surrounding the absorption unit and having pores through which the ammonia is transferred from the wastewater moving unit, wherein the membrane contact device is designed based on a method for predicting membrane contact process performance of a membrane contact device that removes ammonia contained in wastewater, the method including: inputting the wastewater conditions; inputting membrane contact process conditions of the membrane contact device; and predicting the removal rate of ammonia removed from the wastewater using a prediction model that calculates the removal rate of ammonia, the prediction model including equations using the wastewater conditions and the membrane contact process conditions. In one or more other embodiments, the aforementioned wastewater treatment system includes a plurality of membrane contact devices.

Although various embodiments of the present disclosure have been described above, they are not limited thereto, and various modifications may be made within the scope of the patent claims, detailed description, and attached drawings, which should naturally fall within the scope of the present disclosure.

What is claimed is:

1. A method for predicting a membrane contact process performance of a membrane contact device that removes ammonia contained in wastewater, the method comprising:
inputting wastewater conditions;
inputting membrane contact process conditions of the membrane contact device; and
predicting a removal rate of ammonia removed from the wastewater using a prediction model that calculates the removal rate of ammonia, the prediction model comprising equations using the wastewater conditions and the membrane contact process conditions.

2. The method of claim 1, wherein the wastewater conditions comprise at least one selected from the group consisting of pH, temperature, flow rate, and ammonia concentration in the wastewater.

3. The method of claim 1, wherein the membrane contact device comprises:
a wastewater moving unit through which the wastewater moves;
an absorption unit disposed along a flow path of the wastewater in the wastewater moving unit, for absorbing ammonia from the wastewater; and
a separator having a shape surrounding the absorption unit and having pores through which the ammonia is transferred from the wastewater moving unit, and
wherein the predicting step comprises calculating the ammonia removal rate using a mass of ammonia transferred through the pores to the absorption unit.

4. The method of claim 3, wherein the membrane contact process conditions comprise at least one selected from the group consisting of separator length, separator thickness, separator diameter, separator surface area, and diameter of the absorption unit.

5. The method of claim 3, wherein the membrane contact process conditions comprise at least one selected from the group consisting of pore diameter of the separator, porosity of the separator, internal volume in the membrane contact device, and tortuosity of the pores.

6. The method of claim 3, wherein removal of ammonia from the wastewater in the membrane contact process comprises:
vaporizing the ammonia (NH_{3(aq)}) in the wastewater moving unit; and
diffusing the vaporized ammonia (NH_{3(g)}) into the pores of the separator.

7. The method of claim 6, further comprising absorbing diffused ammonia (NH_{3(g)}) into the absorption unit.

8. The method of claim 6, wherein a concentration of diffused ammonia (NH_{3(g)}) calculated by the prediction model is derived using ammonia concentration [NH_{3(aq)}], pH, and temperature of the wastewater as variables.

9. The method of claim 8, further comprising calculating the ammonia concentration [NH_{3(aq)}] in the wastewater by the prediction model with equations (1) to (3):
$$[ {C}_{0} ] = [ {NH}_{{4}^{+} ( a q} ) ] + [ {NH}_{3 ( a q} ) ] \qquad ( 1 )$$
$${K}_{a} = \frac{[ {NH}_{3 ( a q )} ] * [ {H}^{+} ]}{[ {NH}_{4 ( a q )}^{+} ]} \qquad ( 2 )$$
$$[ {NH}_{3 ( a q )} ] = \frac{[ {C}_{0} ] * {K}_{a}}{[ {H}^{+} ] + {K}_{a}} \qquad ( 3 )$$
wherein [C₀] is a total molar concentration of ammonia in the wastewater contained in the wastewater moving unit, [NH₄_{⁺}_{(aq)}] is a molar concentration of ammonium ion in the wastewater contained in the wastewater moving unit, [NH_{3(aq)}] is a molar concentration of ammonia in the wastewater contained in the wastewater moving unit, [H⁺] is a molar concentration of hydrogen ions in the wastewater contained in the wastewater moving unit, and dissociation constant Kₐ is calculated by equation (4):
$${K}_{a} = 1 {0}^{0.05 - ( \frac{2788}{T} )} , \qquad ( 4 )$$
wherein T is the temperature of the wastewater.

10. The method of claim 7, wherein the step of diffusing the vaporized ammonia (NH_{3(g)}) into the separator pores comprises reaching equilibrium between air in the pores and ammonia (NH_{3(g)}).

11. The method of claim 10, further comprising calculating a concentration of ammonia (NH_{3(g)}) in equilibrium in the pores by the prediction model with equations (5) to (7):
$${P}_{{NH}_{3 ( g )}} = {K}_{h} * [ {NH}_{3 ( aq )} ] \qquad ( 5 )$$
$$ln ( {K}_{h} ) = - ( \frac{4092}{T} - 9.7 ) \qquad ( 6 )$$
$$[ {NH}_{3 ( g )} ] = \frac{{P}_{{NH}_{3 ( g )}}}{R ⋆ T} , \qquad ( 7 )$$
wherein P_{NH3(g)} is a partial pressure of ammonia (NH_{3(g)}), Kₕ is Henry's constant, [NH_{3(aq)}] is an ammonia concentration in the wastewater, T is a temperature of the wastewater, and R is the ideal gas constant.

12. The method of claim 10, wherein the step of absorbing diffused ammonia (NH_{3(g)}) into the absorption unit comprises:
transferring equilibrated ammonia (NH_{3(g)}) from the pores to the absorption unit; and
reacting the transferred ammonia (NH_{3(g)}) with acid contained in the separator to form a non-volatile compound.

13. The method of claim 12, wherein a diffusion flux (J) of ammonia (NH_{3(g)}) absorbed into the absorption unit, as calculated by the prediction model, is given by the following equation (8),
$$J = - D \frac{\partial C}{\partial x} \qquad ( 8 )$$
wherein diffusion coefficient (D) represents a diffusion coefficient of ammonia (NH_{3(g)}) in the pores,
$$\frac{\partial C}{\partial x}$$
represents a concentration gradient of the ammonia (NH_{3(g)}) in the pores, and diffusion is performed by at least one of Knudsen diffusion and molecular diffusion.

14. The method of claim 13, wherein the diffusion coefficient (D) is calculated with equations (9) to (13):
$${D}_{k} = \frac{2}{3} * {d}_{p} * ν \qquad ( 9 )$$
$${D}_{m} = \frac{1}{3} * v * λ \qquad ( 10 )$$
$$\frac{1}{D} = \frac{T}{ε} * ( \frac{1}{{D}_{k}} + \frac{1}{{D}_{m}} ) \qquad ( 11 )$$
$$v = \sqrt{\frac{8 * R * T}{π * M}} \qquad ( 12 )$$
$$λ = \frac{{k}_{B} T}{\sqrt{2} π {η}^{2} {P}_{g}} , \qquad ( 13 )$$
wherein Dₖ is a diffusion coefficient of Knudsen diffusion, dₚ is a diameter of the pores, v is a value calculated from equation (12), Dₘ is a diffusion coefficient of molecular diffusion, λ is a mean free path along which ammonia gas (NH_{3(g)}) molecules move without colliding with other gas molecules, τ represents a tortuosity of the pores, E represents a porosity of the separator, R is the ideal gas constant, T is an absolute temperature of the ammonia (NH_{3(g)}), M is a molar mass of the ammonia (NH_{3(g)}) converted to kilogram units (kg/mol), k_{B} is the Boltzmann constant, η is a kinetic diameter of ammonia (NH_{3(g)}), and P_{g} represents gas pressure (10⁵ Pa).

15. The method of claim 13, wherein the diffusion flux (J) of ammonia (NH_{3(g)}) transferred to the absorption unit, as calculated by the prediction model, is further obtained by the following equation (14):
$$J = \frac{D * ε}{τ} * \frac{( [ {NH}_{3 ( g )} ] )}{L} , \qquad ( 14 )$$
wherein D represents the diffusion coefficient of ammonia (NH_{3(g)}) in the pores, E represents a porosity of the separator, τ represents a tortuosity of the pores, [NH_{3(g)}] is an ammonia concentration in the pores, and L is a thickness of the separator.

16. The method of claim 15, wherein a mass (m) of ammonia absorbed in the absorption unit, as calculated by the prediction model, is obtained with the following equation (15),
$$m = J * t * A * ε , \qquad ( 15 )$$
wherein the mass (m) of ammonia varies with the diffusion flux (J) of ammonia (NH_{3(g)}), hydraulic retention time (t), separator area (A), and porosity (ε).

17. The method of claim 16, wherein the ammonia removal rate is calculated using the mass (m) of ammonia, a volume of treated wastewater, and a concentration of ammonia discharged in the treated wastewater.

18. A method for predicting a membrane contact process performance of a membrane contact device that removes ammonia contained in wastewater, the method comprising:
inputting wastewater conditions;
inputting membrane contact process conditions of the membrane contact device;
calculating a concentration of vaporized ammonia (NH_{3(aq)}) in a wastewater moving unit within the membrane contact device;
calculating a diffusion flux (J) of ammonia (NH_{3(g)}) absorbed into an absorption unit through pores of the membrane contact device;
calculating a removal rate of ammonia from a mass (m) of the absorbed ammonia; and
verifying the calculated ammonia removal rate.

19. The method of claim 18, wherein the verifying the calculated ammonia removal rate comprises:
calculating a concentration of ammonia in treated water discharged from the membrane contact device;
deriving an actual ammonia removal rate by comparing the concentration of ammonia in the treated water with a concentration of ammonia in the wastewater; and
comparing the actual ammonia removal rate with the calculated ammonia removal rate.

20. A method for predicting a membrane contact process performance of a membrane contact device that removes ammonia contained in wastewater, the method comprising:
deriving optimal wastewater conditions and optimal membrane contact process conditions of the membrane contact device so that an ammonia removal rate from the wastewater becomes an optimal value;
supplying the wastewater to the membrane contact device under the optimal wastewater conditions;
adjusting the membrane contact process conditions to match the optimal membrane contact process conditions; and
verifying the ammonia removal rate calculated using the optimal wastewater conditions and the optimal membrane contact process conditions.
